(19) United States
(12) Patent Application Publication
(10) Pub. No.: US 2005/0024212 A1
(43) Pub. Date: Feb. 3, 2005

(54) Method and device for detecting the drowsiness state of drivers of moving objects

(76) Inventor: Hagen Hultzsch, Bonn (DE)

Correspondence Address: KENYON & KENYON, ONE BROADWAY, NEW YORK, NY, 10004, US

(21) Appl. No.: 10/498,659

(22) PCT Filed: Dec. 12, 2002
(86) PCT No.: PCT/EP02/14116

(30) Foreign Application Priority Data
Dec. 12, 2001 (LU) 90879

(51) Int. Cl. G08B 23/00

(52) U.S. Cl. 340/575; 340/576

(57) ABSTRACT

The invention relates to a method and a device for monitoring the drowsiness of drivers of moving objects, such as vehicles, aeroplanes, trains, and ships. According to said method, several physiological measurement variables such as e.g. blinking frequency, eyelid pulse frequency, yawning frequency or the state of face muscle relaxation are combined into a summation signal with a differentiated weighting, said signal constituting a final state signal, which indicates the drowsiness with the logic states 0 (zero/e.g. no drowsiness established) or 1 (one/e.g. drowsiness established).

The present invention is directed to a method, as well as to a device for monitoring the drowsiness state of operators of moving objects, such as vehicles, airplanes, trains or ships. The method and the device can likewise be employed to determine the drowsiness state of other persons, such as security guards. When a drowsiness state is recognized, an alarm signal is triggered and/or the moving object is brought to a standstill by appropriate means.

Devices for detecting the drowsiness state are known from GB 2 145 262 A and U.S. Pat. No. 5,402,109. In this context, special glasses are used to determine the state of the eyelid (closed or open). GB 2 215 040 A discusses ascertaining the condition of the eyelid by using a video camera. To make such a determination, as discussed above, DE 32 29 773 uses a series of optical pulses, which are reflected differently depending on the state of the eyelid. These methods and devices have the disadvantage of concentrating only on the state of the eyelid and not being able to detect someone sleeping with his/her eyes open, for example.

The object of the present invention is to reliably detect the drowsiness state of the operator of moving objects and to prevent accidents by subsequently initiating appropriate measures, such as waking up the operator and/or acting on the locomotive characteristics of the moving object.

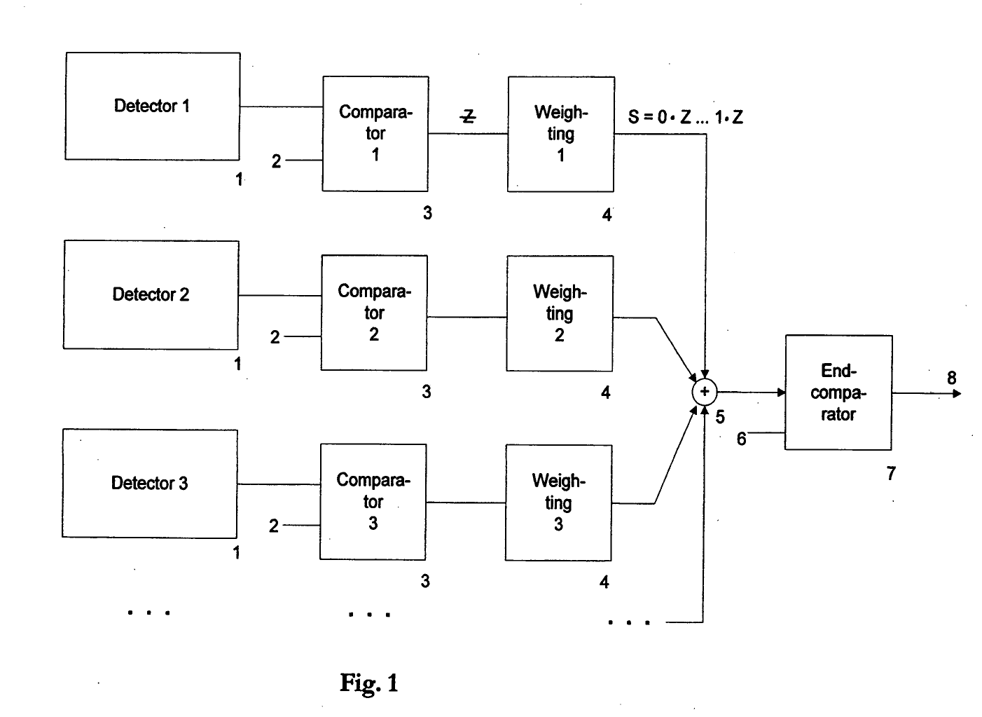

This objective is achieved by the method set forth in claim 1 and, respectively, by the device set forth in claim 6. In this context, a plurality of measured variables, such as eyelid blinking frequency, yawning frequency, and the state of facial muscle relaxation, is determined and processed in accordance with FIG. 1 into a composite signal:
Determining the individual measured variables using detectors 1.
Comparing the detector signals to comparison signals 2 in comparators 3. Each comparator supplies a status signal (z), which may assume logic values 0 (zero) or 1 (one). In this way, it is possible to prevent individual measured variables, which are below a threshold value, from contributing to the composite signal.
Weighting of the status signals with 4, so that signals (s) may assume any desired values between 0 (zero) and 1 (one).
Summing the signals (s) in 5.
Comparing the composite signal to comparison signal 6 in end comparator 7. The result is end-status signal 8, which may assume logic values 0 (zero/e.g., no drowsiness ascertained) and 1 (one/drowsiness ascertained).

Experience shows that the frequency of eyelid blinking decreases with an advancing state of drowsiness and may, therefore, be used as an appropriate measured variable. Moreover, in a state of drowsiness, the eyelid pulse-duty ratio changes, i.e., the ratio between a closed and open eyelid as a function of time. In this context, in the awake state, long phases of an open eyelid are interrupted by short phases of a closed eyelid. As drowsiness advances, the closed-eyelid phases lengthen.

Yawning by the operator of moving objects, i.e., for a brief moment, the eyes are completely or partially closed, and the mouth is wide open, may be determined using optical recognition, by employing an electronic camera and subsequent image processing, such as pattern recognition and by making a comparison to stored images from the awake state.

Relaxation of the facial muscles, particularly in the area of the cheeks, is ascertained, for example, by using strain gauges applied to the facial skin, or with the aid of electronic image processing, such as cameras, pattern recognition, and by making a comparison to the images from the awake state.

In the same way, a combination of the afore-mentioned signals, such as eyelid pulse-duty ratio and state of the facial-muscle relaxation, may constitute an independent measuring signal.

The device according to the present invention may be expanded as needed to include consideration of other physiological measuring signals.

End-status signal 8 may be used as a wake-up signal, an acoustic and/or optical alarm and/or a vibrational alarm being used. Moreover, in response to an ascertained drowsiness, this signal may be used to act in a measured way upon the locomotive characteristics of the moving object. In the process, measures such as uncoupling the engine and transmission (disengaging), cutting off the engine, and/or gentle braking, may be carried out. In trains, this signal may be directly used to release the so-called dead-man brake.

1-29. (Canceled).

30. A method for monitoring a drowsiness state of operators of moving objects, such as vehicles, airplanes, trains, and ships, comprising:
combining a plurality of physiological measured variables, including at least eyelid blinking frequency and eyelid pulse-duty ratio, to form a differently weighted composite signal, which, by states of logic 0 or logic 1, then indicates the drowsiness state as an end-status signal.

31. A method for monitoring a drowsiness state of operators of moving objects, such as vehicles, airplanes, trains, and ships, comprising:
combining a plurality of physiological measured variables, including at least eyelid blinking frequency and yawning frequency, to form a differently weighted composite signal, which, by states of logic 0 or logic 1, then indicates the drowsiness state as an end-status signal.

32. A method for monitoring a drowsiness state of operators of moving objects, such as vehicles, airplanes, trains, and ships, comprising:
combining a plurality of physiological measured variables, including at least an eyelid blinking frequency and a state of facial-muscle relaxation, to form a differently weighted composite signal, which, by states of logic 0 or logic 1, then indicates the drowsiness state as an end-status signal.

33. A method for monitoring the drowsiness state of operators of moving objects, such as vehicles, airplanes, trains, and ships, comprising:
combining a plurality of physiological measured variables, including at least eyelid pulse-duty ratio and yawning frequency, to form a differently weighted composite signal, which, by states of logic 0 or logic 1, then indicates the drowsiness state as an end-status signal.

34. A method for monitoring the drowsiness state of operators of moving objects, such as vehicles, airplanes, trains, and ships, comprising:
combining a plurality of physiological measured variables, including at least eyelid pulse-duty ratio and state of facial-muscle relaxation, to form a differently weighted composite signal, which, by states of logic 0 or logic 1, then indicates the drowsiness state as an end-status signal.

35. A method for monitoring the drowsiness state of operators of moving objects, such as vehicles, airplanes, trains, and ships, comprising:
combining a plurality of physiological measured variables, including at least yawning frequency and state of facial-muscle relaxation, to form a differently weighted composite signal, which, by states of logic 0 or logic 1, then indicates the drowsiness state as an end-status signal.

36. The method as recited in claim 32, wherein, as a further physiological measured variable, a yawning frequency enters into the composite signal.

37. The method as recited in claim 30, wherein, as a further physiological measured variable, a state of relaxation enters into the composite signal.

38. The method as recited in claim 33, wherein, as a further physiological measured variable, eyelid frequency enters into the composite signal.

39. The method as recited in claim 31, wherein, as a further physiological measured variable, eyelid pulse-duty ratio enters into the composite signal.

40. The method as recited in claim 36, wherein, as a further physiological measured variable, eyelid pulse-duty ratio enters into the composite signal.

41. The method as recited in claim 40, wherein a suitable combination of a plurality of physiological measured variables constitutes an independent measuring signal.

42. The method as recited in claim 30, wherein, as a wake-up signal, the end-status signal triggers at least one of an acoustic alarm, an optical alarm, and a vibrational alarm.

43. The method as recited in claim 30, wherein the end-status signal acts on locomotive characteristics of the moving object, it being possible to carry out measures such as uncoupling, switching off an engine and/or gentle braking.

44. The method as recited in claim 30, wherein, in trains, the end-status signal can be directly used to release a dead-man brake.

45. A device for monitoring the drowsiness state of operators of moving objects, such as vehicles, airplanes, trains, and ships, comprising:
a differently weighted composite signal being formed by combining a plurality of physiological measured variables, including at least eyelid blinking frequency and eyelid pulse-duty ratio, which, by states of logic 0 and/or logic 1 then indicates the drowsiness state as end-status signal.

46. A device for monitoring the drowsiness state of operators of moving objects, such as vehicles, airplanes, trains, and ships, comprising:
a differently weighted composite signal being formed by combining a plurality of physiological measured variables, including at least eyelid blinking frequency and the yawning frequency, which, by states of logic 0 and/or logic 1 then indicates the drowsiness state as end-status signal.

47. A device for monitoring the drowsiness state of operators of moving objects, such as vehicles, airplanes, trains, and ships, comprising:
a differently weighted composite signal being formed by combining a plurality of physiological measured variables, including at least eyelid blinking frequency and the state of facial-muscle relaxation, which, by states of logic 0 and/or logic 1 then indicates the drowsiness state as end-status signal.

48. A device for monitoring the drowsiness state of operators of moving objects, such as vehicles, airplanes, trains, and ships, comprising:
a differently weighted composite signal being formed by combining a plurality of physiological measured variables, including at least eyelid pulse-duty ratio and the yawning frequency, which, by states of logic 0 and/or logic 1 then indicates the drowsiness state as end-status signal.

49. A device for monitoring the drowsiness state of operators of moving objects, such as vehicles, airplanes, trains, and ships, comprising:
a differently weighted composite signal being formed by combining a plurality of physiological measured variables, including at least eyelid pulse-duty ratio and state of facial-muscle relaxation, which, by states of logic 0 and/or logic 1 then indicates the drowsiness state as end-status signal.

50. A device for monitoring the drowsiness state of operators of moving objects, such as vehicles, airplanes, trains, and ships, comprising:
a differently weighted composite signal being formed by combining a plurality of physiological measured variables, including at least yawning frequency and the state of facial-muscle relaxation, which, by states of logic 0 and/or logic 1 then indicates the drowsiness state as end-status signal.

51. The device as recited in claim 47, wherein, as a further physiological measured variable, a yawning frequency enters into the composite signal.

52. The device as recited in claim 45, wherein, as a further physiological measured variable, a state of facial-muscle relaxation enters into the composite signal.

53. The device as recited in claim 48, wherein, as a further physiological measured variable, eyelid frequency enters into the composite signal.

54. The device as recited in claim 46, wherein, as a further physiological measured variable, eyelid pulse-duty ratio enters into the composite signal.

55. The device as recited in claim 51, wherein, as a further physiological measured variable, eyelid pulse-duty ratio enters into the composite signal.

56. The device as recited in claim 45, wherein, as a wake-up signal, the end-status signal triggers at least one of an acoustic alarm, an optical alarm, and a vibrational alarm.

57. The device as recited in one of claims 45 through 55, wherein the end-status signal acts on the locomotive characteristics of the moving object, it being possible to carry out measures such as uncoupling, switching off the engine and/or gentle braking.

58. The device as recited in claim 45, wherein, in trains, the end-status signal can be directly used to release a dead-man brake.

59. The method as recited in claim 30, wherein logic 0 indicates no drowsiness ascertained and logic 1 indicates drowsiness ascertained.

60. The method as recited in claim 30, wherein, as a further physiological measured variable, a yawning frequency enters into the composite signal.

61. The method as recited in claim 34, wherein, as a further physiological measured variable, a yawning frequency enters into the composite signal.

62. The method as recited in claim 31, wherein, as a further physiological measured variable, a state of facial-muscle relaxation enters into the composite signal.

63. The method as recited in claim 33, wherein, as a further physiological measured variable, a state of facial-muscle relaxation enters into the composite signal.

64. The method as recited in claim 34, wherein, as a further physiological measured variable, eyelid frequency enters into the composite signal.

65. The method as recited in claim 35, wherein, as a further physiological measured variable, eyelid frequency enters into the composite signal.

66. The method as recited in claim 32, wherein, as a further physiological measured variable, eyelid pulse-duty ratio enters into the composite signal.

67. The method as recited in claim 35, wherein, as a further physiological measured variable, eyelid pulse-duty ratio enters into the composite signal.

68. The method as recited claim 36, wherein a suitable combination of a plurality of physiological measured variables constitutes an independent measuring signal.

69. The method as recited in claim 37, wherein a suitable combination of a plurality of physiological measured variables constitutes an independent measuring signal.

70. The method as recited in claim 38, wherein a suitable combination of a plurality of physiological measured variables constitutes an independent measuring signal.

71. The method as recited in claim 60, wherein a suitable combination of a plurality of physiological measured variables constitutes an independent measuring signal.

72. The method as recited in claim 61, wherein a suitable combination of a plurality of physiological measured variables constitutes an independent measuring signal.

73. The method as recited in claim 62, wherein a suitable combination of a plurality of physiological measured variables constitutes an independent measuring signal.

74. The method as recited in claim 63, wherein a suitable combination of a plurality of physiological measured variables constitutes an independent measuring signal.

75. The method as recited in claim 64, wherein a suitable combination of a plurality of physiological measured variables constitutes an independent measuring signal.

76. The method as recited in claim 65, wherein a suitable combination of a plurality of physiological measured variables constitutes an independent measuring signal.

77. The method as recited in claim 66, wherein a suitable combination of a plurality of physiological measured variables constitutes an independent measuring signal.

78. The method as recited in claim 67, wherein a suitable combination of a plurality of physiological measured variables constitutes an independent measuring signal.

79. The method as recited in claim 31, wherein, as a wake-up signal, the end-status signal triggers at least one of an acoustic alarm, an optical alarm, and a vibrational alarm.

80. The method as recited in claim 32, wherein, as a wake-up signal, the end-status signal triggers at least one of an acoustic alarm, an optical alarm, and a vibrational alarm.

81. The method as recited in claim 33, wherein, as a wake-up signal, the end-status signal triggers at least one of an acoustic alarm, an optical alarm, and a vibrational alarm.

82. The method as recited in claim 34, wherein, as a wake-up signal, the end-status signal triggers at least one of an acoustic alarm, an optical alarm, and a vibrational alarm.

83. The method as recited in claim 35, wherein, as a wake-up signal, the end-status signal triggers at least one of an acoustic alarm, an optical alarm, and a vibrational alarm.

84. The method as recited in claim 31, wherein the end-status signal acts on locomotive characteristics of the moving object, it being possible to carry out measures such as uncoupling, switching off an engine and/or gentle braking.

85. The method as recited in claim 32, wherein the end-status signal acts on locomotive characteristics of the moving object, it being possible to carry out measures such as uncoupling, switching off an engine and/or gentle braking.

86. The method as recited in claim 33, wherein the end-status signal acts on locomotive characteristics of the moving object, it being possible to carry out measures such as uncoupling, switching off an engine and/or gentle braking.

87. The method as recited in claim 34, wherein the end-status signal acts on locomotive characteristics of the moving object, it being possible to carry out measures such as uncoupling, switching off an engine and/or gentle braking.

88. The method as recited in claim 35, wherein the end-status signal acts on locomotive characteristics of the moving object, it being possible to carry out measures such as uncoupling, switching off an engine and/or gentle braking.

89. The method as recited in claim 31, wherein, in trains, the end-status signal can be directly used to release a dead-man brake of the moving object.

90. The method as recited in claim 32, wherein, in trains, the end-status signal can be directly used to release a dead-man brake.

91. The method as recited in claim 33, wherein, in trains, the end-status signal can be directly used to release a dead-man brake.

92. The method as recited in claim 34, wherein, in trains, the end-status signal can be directly used to release a dead-man brake.

93. The method as recited in claim 35, wherein, in trains, the end-status signal can be directly used to release a dead-man brake.

94. The device as recited in claim 45, wherein, as a further physiological measured variable, a yawning frequency enters into the composite signal.

95. The device as recited in claim 49, wherein, as a further physiological measured variable, a yawning frequency enters into the composite signal.

96. The device as recited in claim 46, wherein, as a further physiological measured variable, a state of facial-muscle relaxation enters into the composite signal.

97. The device as recited in claim 48, wherein, as a further physiological measured variable, a state of facial-muscle relaxation enters into the composite signal.

98. The device as recited in claim 49, wherein, as a further physiological measured variable, eyelid frequency enters into the composite signal.

99. The device as recited in claim 50, wherein, as a further physiological measured variable, eyelid frequency enters into the composite signal.

100. The device as recited in claim 47, wherein, as a further physiological measured variable, eyelid pulse-duty ratio enters into the composite signal.

101. The device as recited in claim 50, wherein, as a further physiological measured variable, eyelid pulse-duty ratio enters into the composite signal.

102. The device as recited in claim 46, wherein, as a wake-up signal, the end-status signal triggers at least one of an acoustic alarm, an optical alarm, and a vibrational alarm.

103. The device as recited in claim 47, wherein, as a wake-up signal, the end-status signal triggers at least one of an acoustic alarm, an optical alarm, and a vibrational alarm.

104. The device as recited in claim 48, wherein, as a wake-up signal, the end-status signal triggers at least one of an acoustic alarm, an optical alarm, and a vibrational alarm.

105. The device as recited in claim 49, wherein, as a wake-up signal, the end-status signal triggers at least one of an acoustic alarm, an optical alarm, and a vibrational alarm.

106. The device as recited in claim 50, wherein, as a wake-up signal, the end-status signal triggers at least one of an acoustic alarm, an optical alarm, and a vibrational alarm.

107. The device as recited in claim 46, wherein, in trains, the end-status signal can be directly used to release a dead-man brake.

108. The device as recited in claim 47, wherein, in trains, the end-status signal can be directly used to release a dead-man brake.

109. The device as recited in claim 48, wherein, in trains, the end-status signal can be directly used to release a dead-man brake.

110. The device as recited in claim 49, wherein, in trains, the end-status signal can be directly used to release a dead-man brake.

111. The device as recited in claim 50, wherein, in trains, the end-status signal can be directly used to release a dead-man brake.

112. The method as recited in claim 31, wherein logic 0 indicates no drowsiness ascertained and logic 1 indicates drowsiness ascertained.

113. The method as recited in claim 32, wherein logic 0 indicates no drowsiness ascertained and logic 1 indicates drowsiness ascertained.

114. The method as recited in claim 33, wherein logic 0 indicates no drowsiness ascertained and logic 1 indicates drowsiness ascertained.

115. The method as recited in claim 34, wherein logic 0 indicates no drowsiness ascertained and logic 1 indicates drowsiness ascertained.

116. The method as recited in claim 35, wherein logic 0 indicates no drowsiness ascertained and logic 1 indicates drowsiness ascertained.

117. The method as recited in claim 45, wherein logic 0 indicates no drowsiness ascertained and logic 1 indicates drowsiness ascertained.

118. The method as recited in claim 46, wherein logic 0 indicates no drowsiness ascertained and logic 1 indicates drowsiness ascertained.

119. The method as recited in claim 47, wherein logic 0 indicates no drowsiness ascertained and logic 1 indicates drowsiness ascertained.

120. The method as recited in claim 48, wherein logic 0 indicates no drowsiness ascertained and logic I indicates drowsiness ascertained.

121. The method as recited in claim 49, wherein logic 0 indicates no drowsiness ascertained and logic I indicates drowsiness ascertained.

122. The method as recited in claim 50, wherein logic 0 indicates no drowsiness ascertained and logic I indicates drowsiness ascertained.
